(19) United States
(12) Patent Application Publication
(10) Pub. No.: US 2021/0261154 A1
(43) Pub. Date: Aug. 26, 2021

(54) CONTINUOUS OBSTACLE DETECTION METHOD, DEVICE, AND SYSTEM, AND STORAGE MEDIUM

(71) Applicant: SZ DJI TECHNOLOGY CO., LTD., Shnzhen (CN)

(72) Inventors: Yu WANG, Shenzhen (CN); Li LIN, Shenzhen (CN); Peitao CHEN, Shenzhen (CN)

(21) Appl. No.: 17/202,322

(22) Filed: Mar. 15, 2021

Related U.S. Application Data
(63) Continuation of application No. PCT/CN2018/124887, filed on Dec. 28, 2018.

(51) Int. Cl. B60W 60/00; G06K 9/00; B60W 30/18; G06K 9/62

(52) U.S. Cl. CPC B60W 60/001; G06K 9/00805; B60W 2420/403; G06K 9/6218; B60W 2420/52; B60W 30/18

(57) ABSTRACT

The present disclosure provides a continuous obstacle detection method applied to a vehicle having a radar including an antenna configured to receive an echo signal. The method includes obtaining the echo signal at a current instance, and generating detection data at the current instance based on the echo signal; determining a plurality of stationary target points detected by the radar at the current instance based on the detection data at the current instance and vehicle information of the vehicle at the current instance; and determining a continuous obstacle trajectory at the current instance based on the plurality of stationary target points detected by the radar at the current instance.

### CROSS-REFERENCE TO RELATED APPLICATION

This application is a continuation application of International Application No. PCT/CN2018/124887, filed on Dec. 28, 2018, the entire content of which is incorporated herein by reference.

### TECHNICAL FIELD

The present disclosure relates to the technical field of vehicles and, more specifically, to a continuous obstacle detection method, device, and system, and a storage medium.

### BACKGROUND

With the development of driving assistance technology and automatic driving technology, millimeter wave radars are increasingly used in vehicles. Millimeter wave radar has the advantage of being able to operate in all-weather, with long operating range and high speed measurement accuracy, etc., which makes up for the deficiencies of other sensors such as ultrasound sensors and cameras. In conventional technology, a vehicle can be provided with a millimeter wave radar, and the millimeter wave radar can be used to detect the environment around the vehicle.

However, there is currently no technology that can detect continuous obstacles around the vehicle using millimeter wave radar. Generally, the millimeter wave radar presents the obstacles it detects in the form of dots. This form of presentation cannot determine the continuous obstacles around the vehicle, such as road edges, guardrails, fences, continuous stone posts, etc. Therefore, it is necessary to provide a method to enable the millimeter wave radar to determine such boundary characteristics on the road.

### SUMMARY

One aspect of the present disclosure provides a continuous obstacle detection method applied to a vehicle having a radar including an antenna configured to receive an echo signal. The method includes obtaining the echo signal at a current instance, and generating detection data at the current instance based on the echo signal; determining a plurality of stationary target points detected by the radar at the current instance based on the detection data at the current instance and vehicle information of the vehicle at the current instance; and determining a continuous obstacle trajectory at the current instance based on the plurality of stationary target points detected by the radar at the current instance.

Another aspect of the present disclosure provides a continuous obstacle detection system. The system includes a radar disposed on a vehicle, the radar including an antenna, the antenna being configured to receive an echo signal; a processor; and a memory storing one or more sets of computer program instruction sets that. When executed by the processor, the one or more sets of computer program instructions causes the processor to obtain the echo signal at a current instance, and generate detection data at the current instance based on the echo signal; determine a plurality of stationary target points detected by the radar at the current instance based on the detection data at the current instance and vehicle information of the vehicle at the current instance; and determine a continuous obstacle trajectory at the current instance based on the plurality of stationary target points detected by the radar at the current instance.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a schematic diagram of an application scenario according to an embodiment of the present disclosure.

FIG. 2 is a flowchart of a continuous obstacle detection method according to an embodiment of the present disclosure.

FIG. 3 is a schematic diagram of two-dimensional data according to an embodiment of the present disclosure.

FIG. 4 is a flowchart of filtering a vehicle speed according to an embodiment of the present disclosure.

FIG. 5 is a flowchart of detecting stationary target points according to an embodiment of the present disclosure.

FIG. 6 is schematic diagram of a stationary target point according to an embodiment of the present disclosure.

FIG. 7 is a schematic diagram of another stationary target point according to an embodiment of the present disclosure.

FIG. 8 is a flowchart of the continuous obstacle detection method according to another embodiment of the present disclosure.

FIG. 9 is schematic diagram of a vehicle's own coordinate system according to an embodiment of the present disclosure.

FIG. 10 is a schematic diagram of a clustering according to an embodiment of the present disclosure.

FIG. 11 is a schematic diagram of a continuous obstacle trajectory according to an embodiment of the present disclosure.

FIG. 12 is a flowchart of the continuous obstacle detection method according to another embodiment of the present disclosure.

FIG. 13 is a schematic diagram of clustering at the current time and the continuous obstacle trajectory at a previous time according to another embodiment of the present disclosure.

FIG. 14 is a schematic diagram of clustering at the current time and the continuous obstacle trajectory at a previous time according to another embodiment of the present disclosure.

FIG. 15 is a schematic diagram of another continuous obstacle trajectory according to an embodiment of the present disclosure.

FIG. 16 is a schematic diagram of another continuous obstacle trajectory according to an embodiment of the present disclosure.

FIG. 17 is a schematic diagram of the clustering points at the current time and the previous trajectory points of the continuous obstacle trajectory at a previous time according to an embodiment of the present disclosure.

FIG. 18 is a schematic diagram of another continuous obstacle trajectory according to an embodiment of the present disclosure.

FIG. 19 is a structural diagram of a continuous obstacle detection system according to an embodiment of the present disclosure.

### REFERENCE NUMERALS

11 Vehicle
12 Server
61 Solid line frame
62 Vehicle speed line
63 Stationary target point
64 Stationary target point
1 Cluster
2 Cluster
110 Dotted line
130 Dotted line frame
150 Curve
180 Dotted line frame
190 Continuous obstacle detection system
191 Memory
192 Processor
193 Radar

### DETAILED DESCRIPTION OF THE EMBODIMENTS

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

It should be noted that, when one component is referred to as “fixed to” another component, it may be directly on another component or it is also possible that there is a third component between them. When one component is considered to “connect” another component, it may be directly connected to the other component or it is possible that there is a third component between them.

Unless otherwise defined, all the technical and scientific terms used in the present disclosure have the same or similar meanings as generally understood by one of ordinary skill in the art. As described in the present disclosure, the terms used in the specification of the present disclosure are intended to describe example embodiments, instead of limiting the present disclosure. The term “and/or” as used herein includes any and all combinations of one or more related listed items.

Exemplary embodiments will be described with reference to the accompanying drawings. In the case where there is no conflict between the exemplary embodiments, the features of the following embodiments and examples may be combined with each other.

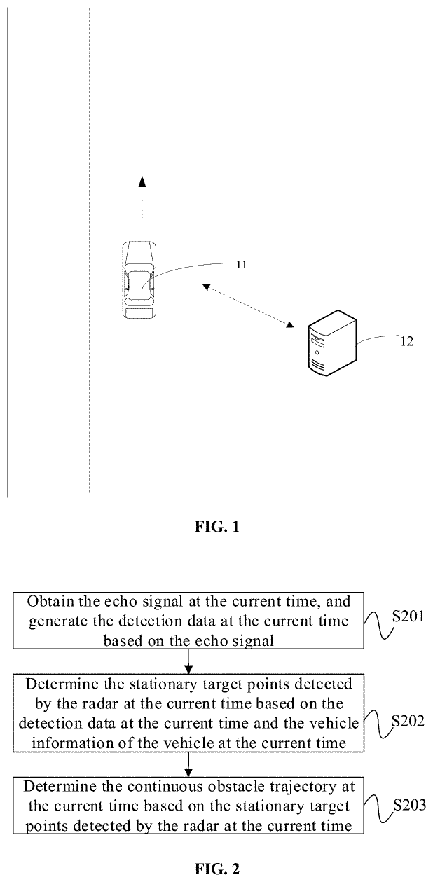

An embodiment of the present disclosure provides a continuous obstacle detection method, which can be applied to a vehicle. The vehicle can include a radar, the radar includes at least an antenna, and the antenna can be used to receive echo signals. In some embodiments, the radar may be a millimeter wave radar. As shown in FIG. 1, a vehicle 11 is driving in the right lane, and the vehicle 11 includes a radar. The radar may be a millimeter wave radar. The millimeter wave radar can be a rear-mounted millimeter wave radar or a front-mounted radar, or the millimeter wave radar may also be integrated in the vehicle.

In this embodiment, the radar may be a frequency modulated continuous wave (FMCW) radar. The FMCW radar may include an antenna, a radio frequency front end, a modulation module, and a signal processing unit. In some embodiments, the radio frequency front end may be used to transmit the detection signal, which can be a linear frequency modulation continuous wave, that is, the frequency of the detection signal emitted by the FMCW radar can be linearly modulated. Specifically, the modulation module may be used to linearly modulate the frequency of the detection signal emitted by the FMCW radar. When the detection signal emitted by the FMCW radar is reflected by objects around the vehicle, the antenna of the FMCW radar will receive the echo signal reflected by the object. The signal processing unit of the FMCW radar can process the echo signal to obtain detection data. In some embodiments, the detection data may include one or more of the energy of a target point detected by the radar, or the distance, speed, and angle of the target point relative to the radar.

In some embodiments, the FMCW radar may also communicate with an onboard processor. When the antenna receives the echo signal, the signal processing unit of the FMCW radar can perform an analog-to-digital conversion on the echo signal, that is, perform a digital sampling on the echo signal. Further, the sampled echo signal can be sent to the onboard processor, and the sampled echo signal can be processed by the onboard processor to obtain the detection data.

In other embodiments, the signal processing unit of the FMCW radar may process the echo signal. After obtaining the detection data, the detection data may also be sent to the onboard processor.

Further, the signal processing unit of the FMCW radar or the onboard processor may also determine continuous obstacles in the lane where the vehicle is positioned based on the detection data. The continuous obstacles may be fences, guardrails, road shoulders, continuous stone posts, etc. on the lane.

In other embodiments, the execution body of the continuous obstacle detection method may not be limited. The execution body of the continuous obstacle detection method may be the signal processing unit of the radar, the processor of the vehicle, a device with data processing function other than the signal processing unit of the radar and the processor on the vehicle, such as a server 12 shown in FIG. 1. In some embodiments, the vehicle 11 may also include a communication module. The communication module may be a wired communication module or a wireless communication module. Take the wireless communication module as an example, when the radar on the vehicle 11, such as the antenna of the FMCW radar, receives the echo signal reflected by the object, the signal processing unit of the FMCW radar can perform an analog-to-digital conversion on the echo signal, that is, a digital sampling of the echo signal. The vehicle 11 can send the echo signal sampled by the signal processing unit to the server 12 through the wireless communication module. The server 12 can process the sampled echo signal, and after obtaining the detection data, determine the continuous obstacles in the lane where the vehicle is positioned based on the detection data. Alternatively, after the signal processing unit of the FMCW radar or the onboard processor obtains the detection data, the vehicle 11 can send the detection data to the server 12 through the wireless communication module. The server 12 can determined the continuous obstacles in the lane where the vehicle is positioned based on the detection data. The continuous obstacle detection method will be described in detail below in conjunction with specific embodiments.

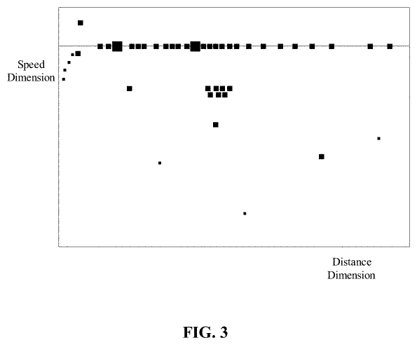

FIG. 2 is a flowchart of a continuous obstacle detection method according to an embodiment of the present disclosure. The method will be described in detail below.

S201, obtaining the echo signal at the current time, and generating the detection data at the current time based on the echo signal.

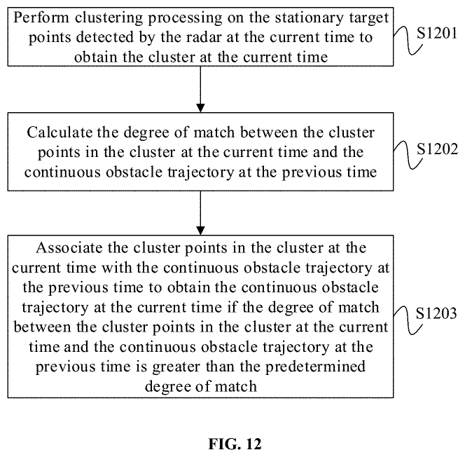

The execution body of the method in this embodiment may be a signal processing unit of a radar, an onboard processor, or the server 12 shown in FIG. 12. The following description takes the signal processing unit of a radar as an example to describe the continuous obstacle detection method in detail.

More specifically, the antenna of the radar can receive echo signals in real time, and the signal processing unit of the radar can generate real-time detection data of the radar based on the echo signals received in real time by the antenna. For example, the signal processing unit can obtain the echo signal received by the antenna at the current time, and perform an analog-to-digital conversion on the echo signal, that is, perform a digital sampling of the echo signal. Then, a fast Fourier transformation (FFT) can be performed on the sampled echo signal. More specifically, the signal processing unit can perform a two-dimensional FFT on the sampled echo signal, that is, the velocity dimension FFT and the distance dimension FFT, to obtain the detection data at the current time. It can be understood that the echo signals received by the antenna at different times may be different. Therefore, the signal processing unit can generate detection data at different times based on the echo signals received by the antenna at different times. Since the target points detected by the radar at different times may be different, the detection data at different times may be different.

In some embodiments, the detection data may include one or more of the energy of the target point detected by the radar, or the distance, speed, and the angle of the target point relative to the radar. In some embodiments, the detection data may be a two-dimensional data composed of a distance dimension and a speed dimension.

In some embodiments, there may be more than one FMCW radar. For example, the FMCW radar may include a plurality of antennas. At the same time, each of the plurality of antennas may receive echo signals. The signal processing unit may perform the analog-to-digital conversion and the two-dimensional FFT on the echo signals received by each antenna to obtain the two-dimensional data composed of the distance dimension and the speed dimension corresponding to each antenna. Further, a multi-channel incoherent accumulation can be performed on the two-dimensional data composed of the distance dimension and the speed dimension corresponding to each antenna to obtain the detection data. In some embodiments, each antenna may correspond to one channel, and the detection data obtained after the multi-channel incoherent accumulation may still be two-dimensional data composed of the distance dimension and the speed dimension. In addition, the two-dimensional data obtained at different times may be different.

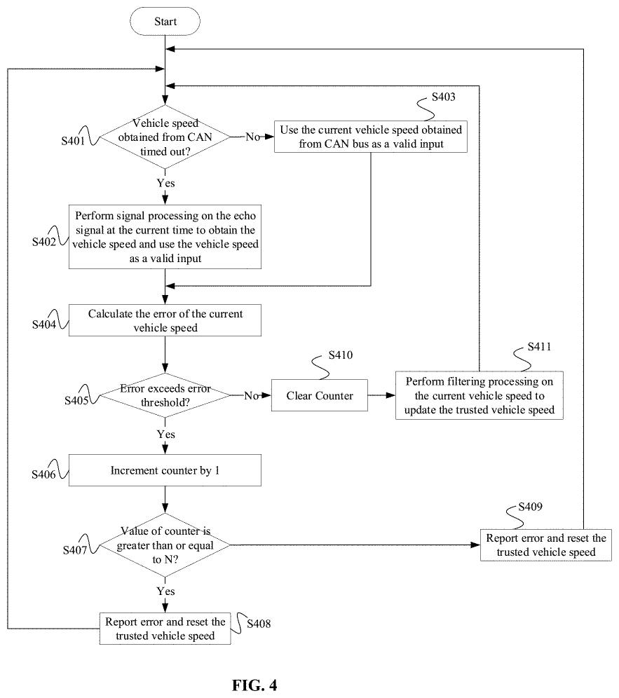

In this embodiment, the two-dimensional data may be an N×M matrix, that is, a matrix of N rows and M columns. As shown in FIG. 3, the horizontal direction represents the distance dimension, the vertical direction represents the speed dimension, the speed dimension includes N speed units, and the distance dimension include M distance units. In some embodiments, N and M may be the equal or unequal, and both N and M are greater than 1. A point on the matrix can be used to represent a target point detected by the radar. The speed corresponding to the target point in the speed dimension can indicate the moving speed of the target point relative to the radar, and the corresponding distance of the target point in the distance dimension can indicate the distance of the target point relative to the radar.

S202, determining the stationary target points detected by the radar at the current time based on the detection data at the current time and the vehicle information of the vehicle at the current time.

As shown in FIG. 3, in the matrix, target points at different positions have different energies, where the points in black represent the target points with energy greater than a predetermined energy threshold. Among the target points whose energy is greater than the predetermined energy threshold, some target points may be stationary target points, and some target points may be moving target points or noise points, where the stationary target points may be target points that are stationary relative to the ground, and the moving target points may be target points that move relative to the ground. This embodiment may determine the stationary target points in the target points based on the target points detected by the radar at the current time, such as the distance and speed of the target points whose energy is greater than the predetermined energy threshold relative to the radar, and the vehicle information of the vehicle at the current time.

In some embodiments, the vehicle information may include one or more of the speed, steering, or yaw rate of the vehicle.

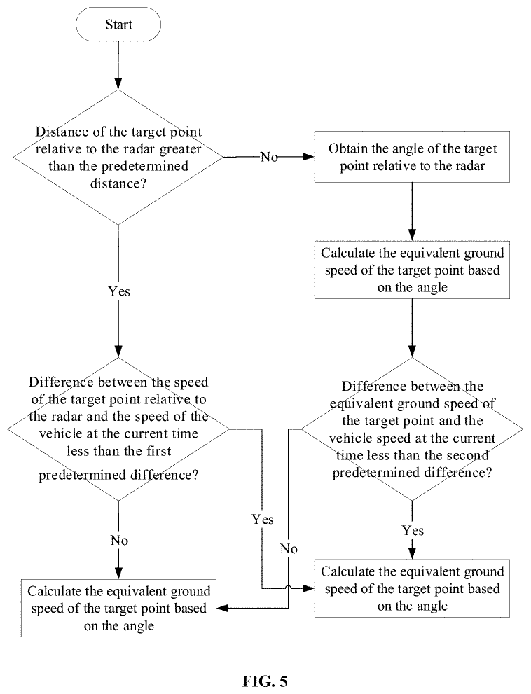

The radar is generally connected to the electrical and electronic systems on the vehicle through a communication bus to obtain vehicle information, such as the vehicle's speed, steering, and yaw rate. For example, the radar can be connected to the vehicle through the controller area network (CAN) bus and obtain the vehicle information of the vehicle from the CAN bus. In addition, the radar can also process the echo signals received by the antenna to obtain vehicle information, such as the speed of the vehicle. In this embodiment, the radar may obtain the vehicle information through the CAN bus or through signal processing. For example, in the process of obtaining the vehicle speed, the obtained vehicle speed can also be filtered. The specific filtering process is as shown in FIG. 4. The process will be described in detail below.

S401, determining whether the vehicle speed obtained from the CAN bus is timed out at the current time, if yes, proceed to the process at S402, otherwise, proceed to the process at S403.

For example, the radar may obtain the vehicle speed from the Can bus at the current time, and determine whether the acquisition of the vehicle speed from the CAN bus at the current time is timed out.

S402, performing signal processing on the echo signal at the current time to obtain the vehicle speed, and using the vehicle speed as a valid input.

If the radar obtains the vehicle speed from the CAN bus at the current time, it can process the echo signal at the current time to obtain the vehicle speed, and use the vehicle speed as a valid point.

S403, using the current vehicle speed obtained from the CAN bus as a valid input.

If the radar obtains the vehicle speed from the CAN bus at the current time is not timed out, the vehicle speed obtained from the CAN bus at the current time can be used as a valid input.

S404, calculating the error of the current vehicle speed.

S405, determining whether the error exceeds an error threshold, if yes, execute the process at S406, other, execute the process at S410.

S406, incrementing the counter by 1.

S407, determining whether the value of the counter is greater than or equal to N, if yes, execute the process at S408, otherwise, execute the process at S409.

S408, reporting an error and resetting the trusted vehicle speed.

S409, maintaining the trusted vehicle speed unchanged.

S410, clearing the counter.

S411, performing filtering processing on the current vehicle speed to update the trusted vehicle speed.

For example, based on the above processes at S401-S403, the corresponding relationship between the determined valid input of the vehicle speed at different times and the trusted vehicle speed at different times are shown in Table 1 or Table 2.

TABLE 1

| Time | T0 | T1 | T2 | T3 | T4 |
|---|---|---|---|---|---|
| Valid Input of Vehicle Speed (m/s) | 10.5 | 10.3 | 13 | 14 | 15 |
| Trusted Vehicle Speed | 10 | 10.2 | 10.2 | 10.2 | 15 |

For example, the valid input of the vehicle speed at time T0 is 10.5, and the error of 105.5 is less than the error threshold, then 10.5 can be filtered to obtain the trusted vehicle speed at time T0, such as 10. The valid input of the vehicle speed at T1 is 10.3, and the error of 10.3 is less than the error threshold, then 10.3 can be filtered. More specifically, based on the trusted vehicle speed 10 at T0 and the value input 10.3 of the vehicle speed at T1, a trusted vehicle speed 10.2 at T1 can be calculated, and the counter at T1 can be cleared. Assume that N=3, the valid input of the vehicle speed at T2 is 13, and the error 13 exceeds the error threshold, then the counter can be incremented by 1. The counter value at T2 is 1, 1 is less than N, and the trusted speed of 10.2 remains unchanged. The valid input of the vehicle speed at T3 is 14, if the error of 14 exceeds the error threshold, the counter will be incremented by 1. The counter value at time T3 is 2, 2 is less than N, and the trusted speed of 10.2 can remain unchanged at this time. The valid input of the vehicle speed at T4 is 15, and the error of 15 exceeds the error threshold, then the counter will be incremented by 1. The counter value at T4 is 3, and 3 is equal to N. At this time, an error can be reported and the trusted vehicle speed can be reset. For example, the trusted vehicle speed can be reset to the valid input of the vehicle speed at T4, which is 15. The subsequent process ca be deduced by analogy and will not be repeated here.

In addition, if the value of the counter has not reached N and a vehicle speed with an error less than the error threshold is entered, the counter can be cleared, and the newly input vehicle speed can be filtered to obtain the new trusted vehicle speed. For example, the valid input of the vehicle speed at T4 is 10.4, and the error of 10.4 is less than the error threshold, the counter can be cleared and 10.4 can be filtered. Based on the valid input 10.2 of the trusted vehicle speed maintained at T3 and 10.4 of the vehicle speed at T4, the trusted vehicle speed at T4 can be calculated, such as 10.3. The details are shown in Table 2 below.

TABLE 2

| Time | T0 | T1 | T2 | T3 | T4 |
|---|---|---|---|---|---|
| Valid Input of Vehicle Speed (m/s) | 10.5 | 10.3 | 13 | 14 | 10.4 |
| Trusted Vehicle Speed | 10 | 10.2 | 10.2 | 10.2 | 10.3 |

In some embodiments, the trusted vehicle speed at different times determined through the above processes can be used as the real vehicle speed at different times, and the real vehicle speed can be used to determine the stationary target points.

In some embodiments, determining the stationary target points detected by the radar at the current time based on the detection data at the current time and the vehicle information of the vehicle at the current time may include determining the stationary target points detected by the radar at the current time based on the speed of the vehicle at the current time, and the distance and speed of the target points detected by the radar at the current time relative to the radar.

As shown in FIG. 3, the stationary target points in the target points can be determined based on the target points detected by the radar at the current time, such as the distance and speed of the target points whose energy is greater than the predetermined energy threshold relative to the radar, and the vehicle speed at the current time. In some embodiments, the vehicle speed of the vehicle at the current time may be the trusted vehicle speed at the current time determined by the method shown in FIG. 4, or may be the valid input of the vehicle speed at the current time as shown in FIG. 4.

In some embodiments, determining the stationary target point detected by the radar at the current time based on the speed of the vehicle at the current time, and the distance and speed of the target points detected by the radar at the current time relative to the radar may include, if the distance of the target point relative to the radar detected by the radar at the current time is greater than a predetermined distance, comparing the speed of the target point relative to the radar with the speed of the vehicle at the current time; and, if the different between the speed of the target point relative to the radar and the speed of the vehicle at the current time is less than a first predetermined difference, determining the target point as the stationary target point detected by the radar at the current time.

Take the points in black in FIG. 3, that is, the target points whose energy is greater than the predetermined energy threshold as an example. As shown in FIG. 5, whether the distance of the target point relative to the radar is greater than the predetermined distance can be first determined. If the distance of the target point relative to the radar is greater than the predetermined distance, the speed of the target point relative to the radar can be compared with the speed of the vehicle at the current time. Further, whether the difference between the speed of the target point relative to the radar and the speed of the vehicle at the current is less than the first predetermined difference can be determined. If the difference between the speed of the target point relative to the radar and the speed of the of the vehicle at the current is less than the first predetermined difference, the target point can be determined as a stationary target point, otherwise, the target point can be discarded.

In some embodiments, determining the stationary target point detected by the radar at the current time based on the speed of the vehicle at the current time, and the distance and speed of the target points detected by the radar at the current time relative to the radar may include, if the distance of the target point detected by the radar at the current time relative to the radar is less than or equal to the predetermined distance, determining the equivalent ground speed of the target point based on the angle of the target point relative to the radar; and comparing the equivalent ground speed of the target point with the speed of the vehicle at the current time; and, if the difference between the equivalent ground speed of the target point and the speed of the vehicle at the current is less than a second predetermined difference, determining the target point as the stationary target point detected by the radar at the current time.

As shown in FIG. 5, whether the distance of the target point relative to the radar is greater than the predetermined distance can be first determined. If the distance of the target point relative to the radar is less than or equal to the predetermined distance, the angle of the target point relative to the radar can be obtained. Then, based on the angle of the target point relative to the radar, the equivalent ground speed of the target point can be calculated. In some embodiments, the speed of the target point in the detected two-dimensional data may be the component of the equivalent ground speed in the radial direction relative to the radar. Therefore, the equivalent ground speed can be calculated based on the detection speed of the target point and its angle to the radar. Further, the equivalent ground speed of the target point can be compared with the speed of the vehicle at the current time, and whether the difference between the equivalent ground speed of the target point and the speed of the vehicle at the current time is less than the second predetermined can be determined. If the difference between the equivalent ground speed of the target point and the speed of the vehicle at the current time is less than the second predetermined difference, the target point can be determined as the stationary target point, otherwise, the target point can be discarded.

For example, after detecting each target point whose energy is greater than the predetermined energy threshold shown in FIG. 3 based on the method shown in FIG. 5, the stationary target points in the target points whose energies are greater than the predetermined energy threshold can be determined. The stationary target points are shown in FIG. 6, where the stationary target points in the solid line frame 61 are the stationary target points closer to the radar, and reference numeral 62 represents the vehicle speed line.

In some embodiments, based on FIG. 6, the stationary target points can be further filtered. More specifically, the stationary target points can be filtered based on the distance of the stationary target points relative to the radar. For example, the stationary target points whose distance to the radar is less than the minimal distance threshold can be removed, and the stationary target points whose distance relative to the radar is greater than the maximum distance threshold can be removed. Since different radars have different field of view (FOV), the reliability of the same target point in the distance detected by different radars may be different. For radars with a narrow detection signal beam, the reliability of detecting the target point at far is relatively higher. For radars with a wide detection signal beam, the reliability of detecting the target point at far is relative low. Therefore, in this embodiment, a maximum distance threshold can be set to remove stationary target points whose distance to the radar is greater than the maximum distance threshold. In addition, when the stationary target point relatively close to the radar, the echo signal received by the radar may have more noise. In this embodiment, a minimum distance threshold can be set to remove stationary target points whose distance to the radar is less than the minimum distance threshold. In addition, in other embodiments, the stationary target points can also be filtered based on the speed of the stationary target points relative to the radar.

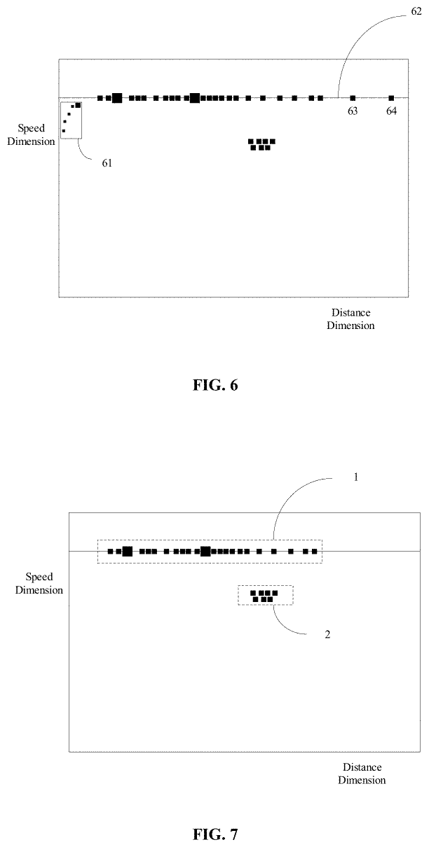

As shown in FIG. 6, the distances of the stationary target points relative to the radar in the solid line frame 61 are less than the minimum distance threshold. The distance between a stationary target point 63 and a stationary target point 64 relative to the radar as shown in FIG. 6 is greater than the maximum distance threshold. After removing the stationary target points in the solid line frame 61, as well as the stationary target point 63 and the stationary target point 64, the stationary target points as shown in FIG. 7 can be obtained. By filtering the stationary target points, not only can the storage space needed by the stationary target points be reduce and the amount of calculation can be reduced, but the probability of misjudgment of the stationary target points can be reduced and the accuracy of the continuous obstacle trajectory fitting can be improved.

In some other embodiments, if the number of stationary target points determined by the radar signal processing unit based on the echo signal received by the antenna at the current time is relatively limited, the signal processing unit may also perform a multi-frame accumulation on the stationary target points. For example, the signal processing unit determines seven stationary target points at time t1, and eight stationary target points at time t2 after time t1, based on the displacement of the vehicle from time t1 to time t2, the stationary target points at time t1 can be compensated, and the compensated stationary target points and the stationary target points determined at time t2 can be accumulated to increase the density of the stationary target points. For example, at time t1, the seven stationary target points are at 80 meters, 81 meters, 82 meters, 83 meters, 84 m meters 85 meters, and 86 meters in front of the vehicle. The vehicle moves 10 meters forward from time t1 to time t2, at time t2, the seven stationary target points are 70 meters, 71 meters, 72 meters, 73 meters, 74 m meters 75 meters, and 76 meters in front of the vehicle. Therefore, the seven stationary target points at time t1 after position compensation and the stationary target points determined at time t2 can be accumulated.

S203, determining a continuous obstacle trajectory at the current time based on the stationary target points detected by the radar at the current time.

Since continuous obstacles such as fences, guardrails, road shoulders, continuous stone posts, or green belts on the lane stationary objects relative to the ground, the stationary target points determined by the above processes can be used as the target points for fitting the continuous obstacles. More specifically, based on the stationary target points determined at the current time, the continuous obstacle trajectory at the current time can be determined.

In some embodiments, determining the continuous obstacle trajectory at the current time based on the stationary target points detected by the radar at the current time may include generating the continuous obstacle trajectory at the current time based on the stationary target points detected by the radar at the current time.

For example, in the initial stage of establishing the continuous obstacle trajectory, there may be no continuous obstacle trajectory in the previous time. At this time, the continuous obstacle trajectory at the current time may be generated based on the stationary target points detected by the radar at the current time.

In some embodiments, determining the continuous obstacle trajectory at the current time based on the stationary target points detected by the radar at the current time may include, based on the stationary target points detected by the radar at the current time, updating the continuous obstacle trajectory at a previous time to obtain the continuous obstacle trajectory at the current time.

For example, the continuous obstacle trajectory has been established at a previous time, and a new is determined based on the stationary target points detected by the radar at the current time, then the degree of match between the new trajectory and the continuous obstacle trajectory at the previous time can be calculated. If the degree of match between the new trajectory and the continuous obstacle trajectory at the previous time is greater than a predetermined degree of match, the new trajectory can be associated with the continuous obstacle trajectory at the previous time, thereby updating the continuous obstacle trajectory at the previous time and obtaining the continuous obstacle trajectory at the current time.

In some embodiments, after determining the continuous obstacle trajectory at the current time based on the stationary target points detected by the radar at the current time, the method may further include determining a boundary of the lane where the vehicle is positioned at the current time based on the continuous obstacle trajectory at the current time. The boundary of the lane where the vehicle is positioned may be further applied to the field of assisted driving or autonomous vehicle.

In this embodiment, the echo signal at the current time can be obtained, the detection data at the current time can be generated based on the echo signal, the stationary target points detected by the radar at the current time can be determined based on the detection data at the current time and the vehicle information of the vehicle at the current time, and continuous obstacle trajectory at the current time can be determined based on the stationary target points detected by the radar at the current time, thereby realizing the detection of continuous obstacles around the vehicle.

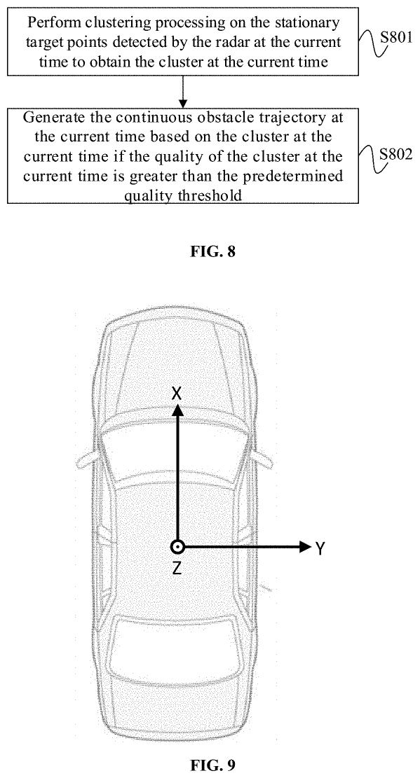

An embodiment of the present disclosure provides a continuous obstacle detection method. FIG. 8 is a flowchart of the continuous obstacle detection method according to another embodiment of the present disclosure. As shown in FIG. 8, based on the above embodiment, generating the continuous obstacle trajectory at the current time based on the stationary target points detected by the radar at the current time may include the following processes.

S801, performing clustering processing on the stationary target points detected by the radar at the current time to obtain the cluster at the current time.

For example, based on FIG. 7, a clustering processing can be performed on the stationary target points selected at the current time to obtain the cluster at the current time, such as a cluster 1 and a cluster 2 shown in FIG. 7.

The present disclosure odes not limit the clustering algorithm used on the clustering processing. For example, the clustering algorithm may be a density-based clustering algorithm (density-based spatial clustering of applications with noise (DB SCAN), or ordering points to identify the clustering structure (OPTICS), or DENsity-based CLUstEring (DENCLUE)) or a random sample consensus algorithm.

S802, if the quality of the cluster at the current time is greater than a predetermined quality threshold, generating the continuous obstacle trajectory at the current time based on the cluster at the current time.

In some embodiments, if the quality of the cluster at the current time is greater than the predetermined quality threshold, then before generating the continuous obstacle trajectory at the current time based on the cluster at the current time, the method may further include determining the quality of the cluster at the current time based on one or more of the number of cluster points in the cluster at the current time, the length of the cluster, or the degree of match between the cluster and the vehicle information of the vehicle.

For example, the cluster 1 and the cluster 2 in FIG. 7 can be scored, respectively. The scoring basis may be one or more of the number of cluster points in the cluster at the current time, the length of the cluster, and the degree of match between the cluster and the vehicle information of the vehicle. The higher the score, the better the quality of the cluster. More specifically, cluster 1 may be scored based on one or more of the number of cluster points in cluster 1, the length of the cluster 1, and the degree of match between the cluster 1 and the vehicle information of the vehicle, to obtain a score 1. Similarly, a score 2 may be calculated for cluster 2. Since the number of cluster points in cluster 1 is more than the number of cluster points in cluster 2, the length of the cluster 1 is greater than the length of the cluster 2, and the speed of the clusters points in cluster relative to the radar is closer to the speed of the vehicle, therefore, the score 1 of cluster 1 is greater than the score 2 of cluster 2, which shows that the quality of cluster 1 is higher than the quality of cluster 2, and the reliability of cluster 1 is higher than the reliability of cluster 2.

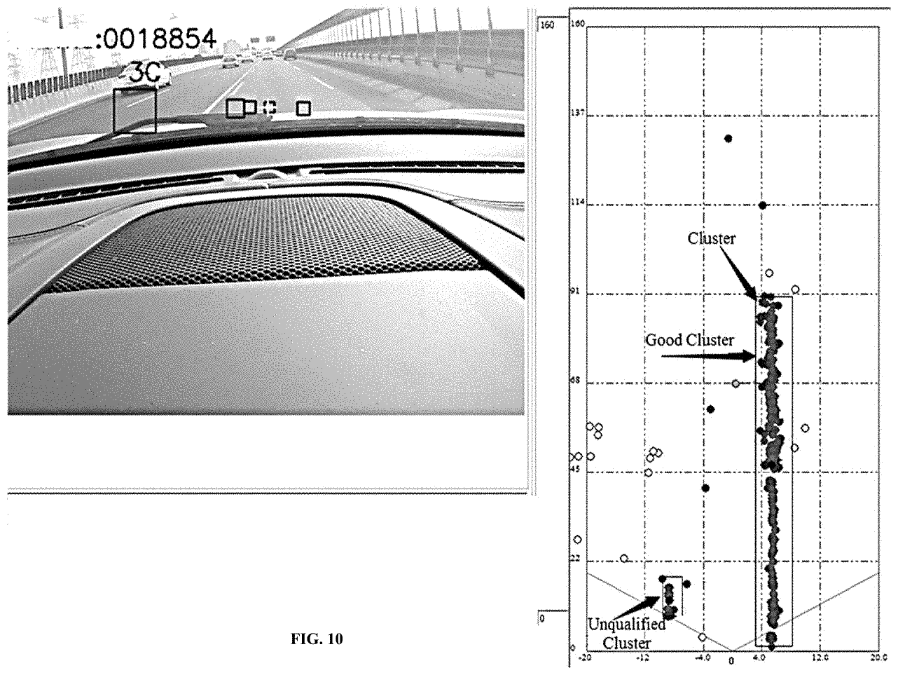

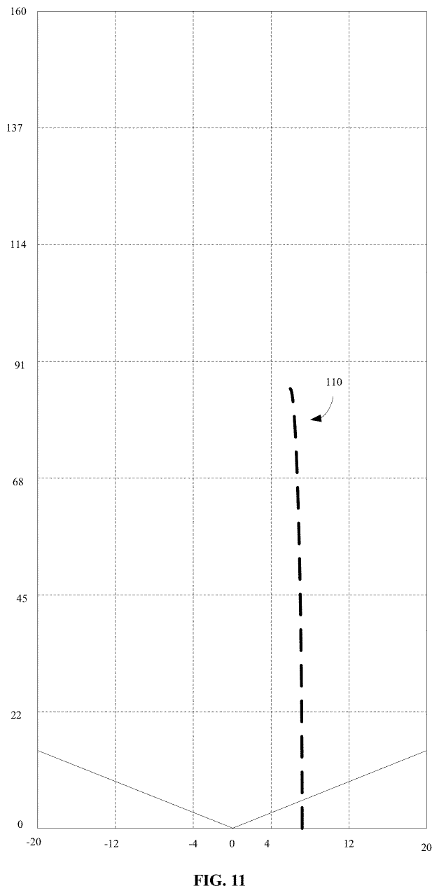

In some embodiments, the target points detected by the radar may be converted from the matrix composed of the distance dimension and the speed dimension to the vehicle's own coordinate system. FIG. 9 is schematic diagram of a vehicle's own coordinate system according to an embodiment of the present disclosure, where the x-axis direction represents the front of the vehicle, the y-axis direction represents the right direction of the vehicle, the z-axis direction represents the direction perpendicular to the ground point to the center of the earth, or the z-axis direction represents the direction perpendicular to the gourd away from the center of the earth. A schematic diagram after the target points detected by the radar are converted from the matrix composed of the distance dimension and the speed dimension to the vehicle's own coordinate system is shown in FIG. 10, where the black points represent the stationary target points. After clustering the stationary target points, two clusters as shown in FIG. 10 are obtained. After scoring the two clusters separately based on the above method, a good cluster and an unqualified cluster can be determined. In some embodiments, a good cluster may be a cluster with a score greater than a predetermined score, that is, a cluster with a quality greater than the predetermined quality threshold. An unqualified cluster may be a cluster whose score after scoring is less than the predetermined score, that is, a cluster with a quality is less than the predetermined quality threshold. In some embodiments, a cluster with a higher score may also be a cluster with higher reliability. For example, the good cluster shown in FIG. 10 is a cluster with more continuous cluster points detected for a first time. Then the continuous obstacle trajectory at the current time can be generated based on the good cluster at the current time, and the continuous obstacle trajectory can be the initial trajectory of the continuous obstacle. As the radar antenna continuously receives echo signals, the signal processing unit of the radar car continuously filter out the new stationary target points, and cluster the stationary target points to obtain the new continuous obstacle trajectory.

More specifically, generating the continuous obstacle trajectory at the current time based on the good cluster at the current time may include performing parameter fitting on the good cluster at the current time to obtain parameter information of the continuous obstacle trajectory at the current time. The parameter information can uniquely describe the continuous obstacle trajectory at the current time, and the schematic diagram of the continuous obstacle trajectory can be the dotted line 110 shown in FIG. 11.

In some embodiments, the polynomial fitting can be used to fit the parameters of the good cluster at the current time, or the radius arc fitting method can be used to fit the parameters of the good cluster at the current time. In some embodiments, the polynomial fitting method can be divided into first-order fitting, second-order fitting, and third-order fitting. Take the second-order fitting as an example, the parameter information obtained after parameter fitting of the good cluster at the current time may include a zero-order coefficient, a first-order coefficient, a second-order coefficient, closest distance information, and farthest distance information, where the closest distance information and the farthest distance information may both refer to the distance relative to the radar or the vehicle. If the radius arc fitting method is used to perform the parameter fitting on the good cluster at the current time, the parameter information obtained after fitting may include a center position, a radius, a starting arc, and an ending arc.

In some embodiments, after generating the continuous obstacle trajectory at the current time based on the cluster at the current time, the continuous obstacle trajectory at the current time and/or the parameter information of the continuous obstacle trajectory may also be output. As shown in FIG. 11, the continuous obstacle trajectory, such as the dotted line 110, and/or the parameter information of the continuous obstacle trajectory is displayed in the display component of the vehicle or the display component of the server. Since the continuous obstacle trajectory at different times may be changed, the continuous obstacle trajectory and/or the parameter information of the continuous obstacle trajectory displayed on the display component may also be constantly changing.

In this embodiment, clustering processing can be performed on the stationary target points detected by the radar at the current time to obtain the cluster at the current time. If the quality of the cluster at the current time is greater than the predetermined quality threshold, the continuous obstacle trajectory at the current time can be generated based on the cluster at the current time, thereby realizing the method of establishing the continuous obstacle trajectory at the initial of detecting the continuous obstacle.

An embodiment of the present disclosure provides a continuous obstacle detection method. FIG. 12 is a flowchart of the continuous obstacle detection method according to another embodiment of the present disclosure. Based on the foregoing embodiments, the continuous obstacle trajectory may have been established at a previous time. If, based on the echo signal received by the radar antenna at the current time, and after determining the stationary target points detected by the radar at the current time, the continuous obstacle trajectory at the previous time can be updated based on the stationary target points detected by the radar at the current time to obtained the continuous obstacle trajectory at the current time. As shown in FIG. 12, updating the continuous obstacle trajectory at the current time based on the stationary target points detected by the radar at the current time to obtain the continuous obstacle trajectory at the current time may include the following processes.

S1201, performing clustering processing on the stationary target points detected by the radar at the current time to obtain the cluster at the current time.

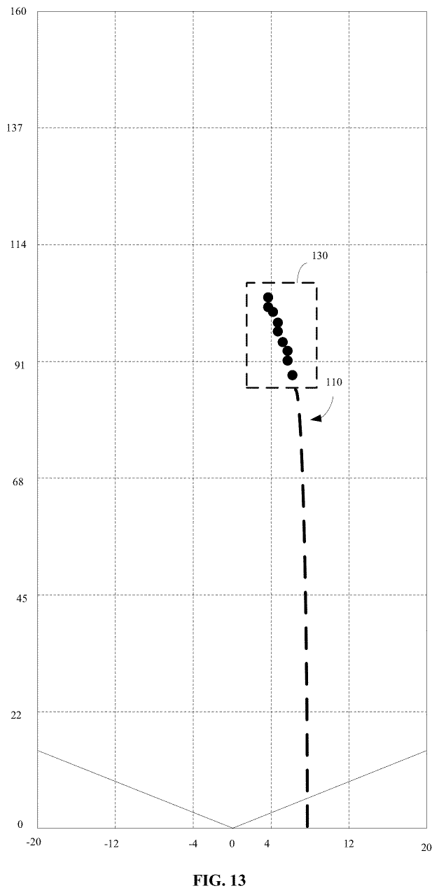

As shown in FIG. 13, assume that the continuous obstacle trajectory shown by the dotted line 110 is the continuous obstacle trajectory established at the previous time, the cluster in a dotted line frame 130 is the cluster at the current time obtained after clustering the stationary target points detected by the radar at the current time.

S1202, calculating the degree of match between the cluster points in the cluster at the current time and the continuous obstacle trajectory at the previous time.

In some embodiments, before calculating the degree of match between the cluster points in the cluster at the current time and the continuous obstacle trajectory at the previous time, the method may further include determining the quality of the cluster at the current time based on one or more of the number of cluster points in the cluster at the current time, the length of the cluster, and the degree of match between the cluster and the vehicle information of the vehicle. Correspondingly, calculating the degree of match between the cluster points in the cluster at the current time and the continuous obstacle trajectory at the previous time may include calculating the degree of match between the cluster points in the cluster at the current time and the continuous obstacle trajectory at the previous time if the quality of the cluster at the current time is greater than the predetermined quality threshold.

For example, after performing clustering processing on the stationary target points detected by the radar at the current time and obtain the cluster in the dotted line frame 130 as shown in FIG. 13, the cluster can be scored based on one or more of the number of cluster points in the cluster, the length of the cluster, or the degree of match between the cluster and the vehicle information of the vehicle. If the score after scoring is greater than the predetermined score, the quality of the cluster may be greater than the predetermined quality threshold. Further, the degree of match between the cluster and the continuous obstacle trajectory at the previous time can be calculated.

In some embodiments, calculating the degree of match between the cluster points in the cluster at the current time and the continuous obstacle trajectory at the previous time may include calculating the degree of match between the cluster points in the cluster at the current time and the continuous obstacle trajectory at the previous time based on the distance of the cluster points in the cluster relative to the radar at the current time and the distance of the previous trajectory points in the continuous obstacle trajectory at the previous time relative to the radar; and/or, calculating the degree of match between the cluster points in the cluster at the current time and the continuous obstacle trajectory at the previous time based on the speed of the cluster points in the cluster relative to the radar at the current time and the speed of the previous trajectory points in the continuous obstacle trajectory at the previous time relative to the radar.

For example, the average distance of each cluster point relative to the radar can be calculated based on the distance of each cluster point in the dotted line frame 130 relative to the radar. The average distance of each previous trajectory point relative to the radar can be calculated based on the continuous obstacle trajectory at the previous time, such as the distance of each previous trajectory point in the dotted line 110 relative to the radar. Further, the average distance of each cluster point relative to the radar in the dotted line frame 130 can be compared with the average distance of each previous trajectory point relative to the radar. If the difference between the two is less than a predetermined value, the degree of match between the cluster points in the dotted line frame 130 and the continuous obstacle trajectory at the previous time can be determined to be greater than a predetermined degree of match.

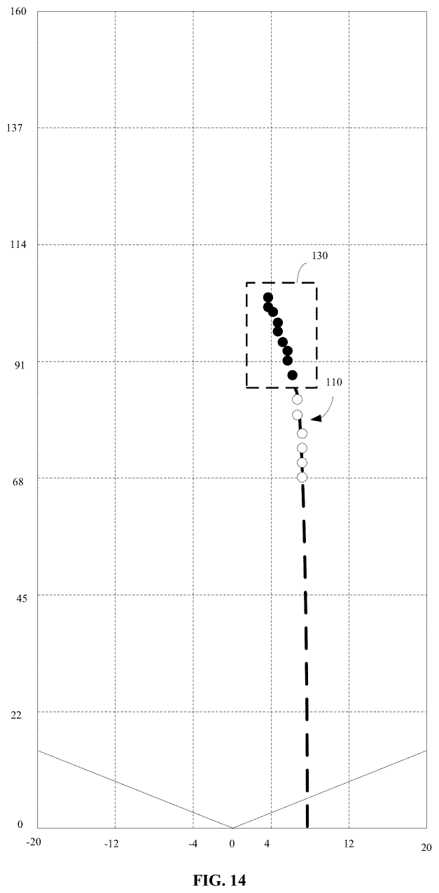

Alternatively, the continuous obstacle trajectory at the previous time, such as the plurality of previous trajectory points near the dotted line frame 130 in the dotted line 110, can be selected. The plurality of previous trajectory points are shown as the white points in FIG. 14. The degree of match can be calculated between the cluster points in the dotted line frame 130 and the continuous obstacle trajectory at the previous time by using the distance of each cluster point in the dotted line frame 130 relative to the radar and the distance of each white point relative to the radar. It can be understood that the method of calculating the degree of match between the cluster points in the dotted line frame 130 and the continuous obstacle trajectory at the previous time is not limited hereto, and other methods can also be used to calculate the degree of match between the cluster points in the dotted line frame 130 and the continuous obstacle trajectory at the previous time.

For example, the degree of match between the cluster points in the dotted line frame 130 and the continuous obstacle trajectory at the previous time can also be calculated based on the speed of each cluster point in the dotted line frame 130 relative to the radar and the continuous obstacle trajectory at the previous time, such as the speed of each history trajectory point in the dotted line 110 relative to the radar. More specifically, the calculation of the degree of match between the cluster points in the dotted line frame 130 and the continuous obstacle trajectory at the previous time may not be limited to comparing the average speed of each cluster point in the dotted line frame 130 relative to the radar and the continuous obstacle trajectory at the previous time, such as the average speed of each previous trajectory point in the dotted line 110 relative to the radar.

In some embodiments, calculating the degree of match between the cluster points in the cluster at the current time and the continuous obstacle trajectory at the previous time may include performing parameter fitting on the cluster at the current time to obtain the parameter information of the new trajectory corresponding to the cluster at the current time; and calculating the degree of match between the cluster points at the current time and the continuous obstacle trajectory at the previous time based on the parameter information of the new trajectory corresponding to the cluster at the current time and the parameter of the continuous obstacle trajectory at the previous time.

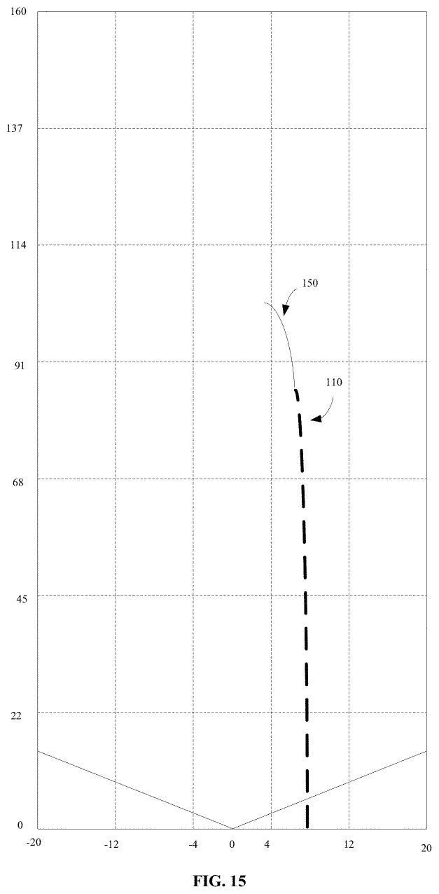

As shown in FIG. 13, performing clustering processing on the stationary target points detected by the radar at the current time can obtain the cluster in the dotted line frame 130 as shown in FIG. 13. After determining that the quality of the cluster is greater than the predetermined quality threshold, parameter fitting may be further performed on the cluster in the dotted line frame 130 to obtain the parameter information of the new trajectory c to the cluster in the dotted line frame 130. The new trajectory is a curve 150 as shown in FIG. 15. In some embodiments, the parameter fitting of the cluster at the current time may use one or more of a polynomial fitting method to perform parameter fitting on the cluster at the current time, or a radius arc fitting method to perform parameter fitting on the cluster at the current time. The process of performing parameter fitting on the cluster in the dotted line frame 130 is consistent with the process of obtaining the dotted line 110 by fitting, which will not be repeated here.

For example, take the second-order fitting as an example, after the second-order fitting method is used to perform parameter fitting on the cluster in the dotted line frame 130, the parameter information corresponding to the curve 150 can be obtained. Further, based on the parameter information corresponding to the curve 150 and the continuous obstacle trajectory at the previous time, such as the parameter information of the dotted line 110, the degree of match between the cluster points in the dotted line frame 130 and the continuous obstacle trajectory at the previous time can be calculated. For example, the parameter information corresponding to the curve 150 may include a zero-order coefficient, a first-order coefficient, a second-order coefficient, closest distance information, and farthest distance information, and the parameter information of the continuous obstacle trajectory at the previous time may also include a zero-order coefficient, a first-order coefficient, a second-order coefficient, closest distance information, and farthest distance information. Sequentially calculate the difference between the zero-order coefficient corresponding to the curve 150 and the zero-order coefficient corresponding to the continuous obstacle trajectory at the previous time, the difference between the first-order coefficient corresponding to the curve 150 and the first-order coefficient corresponding to the continuous obstacle trajectory at the previous time, the difference between the second-order coefficient corresponding to the curve 150 and the second-order coefficient corresponding to the continuous obstacle trajectory at the previous time, the difference between the closest distance corresponding to the curve 150 and the closest distance corresponding to the continuous obstacle trajectory at the previous time, and the difference between the farther distance corresponding to the curve 150 and the farther distance corresponding to the continuous obstacle trajectory at the previous time. If the aforementioned differences are all within a predetermined range, the degree of match between the cluster points in the dotted line frame 130 and the continuous obstacle trajectory at the previous time may be determined to be greater than the predetermined degree of match.

S1203, associating the cluster points in the cluster at the current time with the continuous obstacle trajectory at the previous time to obtain the continuous obstacle trajectory at the current time if the degree of match between the cluster points in the cluster at the current time and the continuous obstacle trajectory at the previous time is greater than the predetermined degree of match.

For example, if the degree of match between the cluster points in the dotted line frame 130 and the continuous obstacle trajectory at the previous time is greater than the predetermined degree of match, then the cluster points in the dotted line frame 130 and the continuous obstacle trajectory at the previous time, such as the dotted line 110, can be associated to obtained the continuous obstacle trajectory at the current time.

In some embodiments, associating the cluster points in the cluster at the current time with the continuous obstacle trajectory at the previous time to obtain the continuous obstacle trajectory at the current time may include obtaining the new trajectory corresponding to the cluster at the current time based on the cluster points in the cluster at the current time; and, associating the new trajectory corresponding to the cluster at the current time with the continuous obstacle trajectory at the previous time to obtain the continuous obstacle trajectory at the current time, the continuous obstacle trajectory at the current time including the new trajectory and the continuous obstacle trajectory at the previous time.

For example, the parameter information of the curve 150 can be obtained by performing parameter fitting on the cluster points in the dotted line frame 130. The curve 150 may be the new trajectory obtained from the cluster points in the dotted line frame 130, and the new trajectory may be associated with the continuous obstacle trajectory at the previous time, such as the dotted line 110, to obtain the continuous obstacle trajectory at the current time. As shown in FIG. 15, the continuous obstacle trajectory at the current time includes the new trajectory, namely the curve 150, and the continuous obstacle trajectory at the previous, such as the dotted line 110.

In some embodiments, the new trajectory may be connected to the continuous obstacle trajectory at the previous time. For example, from the previous time to the current time, the continuous obstacle may not have been interrupted, or the continuous obstacle may not have been blocked. In this case, the new trajectory, that is, the curve 150 and the continuous obstacle trajectory at the previous time, such as the dotted line 110, may be directly connected, as shown in FIG. 15.

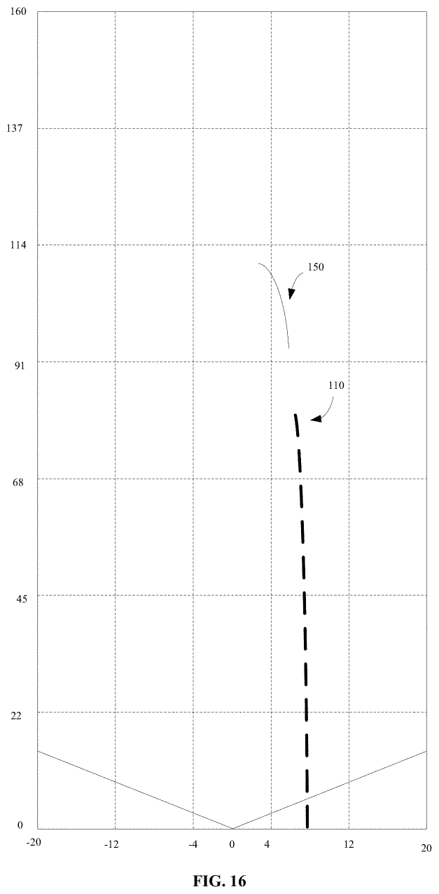

In some other embodiments, the new trajectory may not be connected to the continuous obstacle trajectory at the previous time. For example, from the previous time to the current time, the continuous obstacle may be interrupted, or the continuous obstacle may be blocked by other objects. The new trajectory obtained by clustering at the current time may not be directly connected with the continuous obstacle trajectory at the previous time, as shown in FIG. 16. However, in this case, the new trajectory and the continuous obstacle trajectory at the previous time may also be related, but the continuous obstacle trajectory is broken. The new trajectory, that is, the curve 150 and the continuous obstacle trajectory at the previous time, such as the dotted line 110, together can constitute the continuous obstacle trajectory at the current time.

In other embodiments, associating the cluster points in the cluster at the current time with the continuous obstacle trajectory at the previous time to obtain the continuous obstacle trajectory at the current time may include associating the cluster points in the cluster at the current time with the previous trajectory points in the continuous obstacle trajectory at the previous time to obtain the target points of the continuous obstacle trajectory at the current time; and, determining the continuous obstacle trajectory at the current time based on the target points of the continuous obstacle trajectory at the current time.

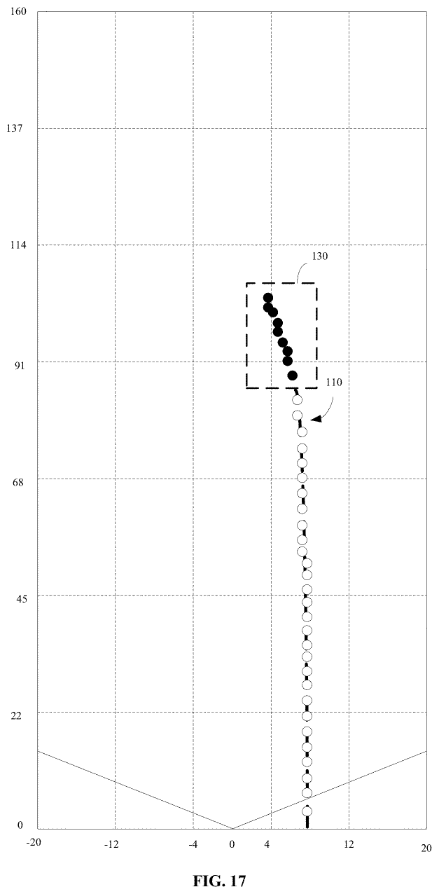

As shown in FIG. 17, the white points represent the continuous obstacle trajectory at the previous time, such as each previous trajectory points in dotted line 110. When associating the cluster points in the dotted line frame 130 with the continuous obstacle trajectory at the previous time, specifically, the cluster points in the dotted line frame 130 and the continuous obstacle trajectory at the previous time, such as the previous trajectory points in the dotted line 110, can be used to form a large set, and the above-mentioned fitting method can be used to perform parameter fitting on the points in the set to obtain the parameter information of a new trajectory. The new trajectory is the trajectory formed by the curve 150 and the dotted line 110 as shown in FIG. 15.

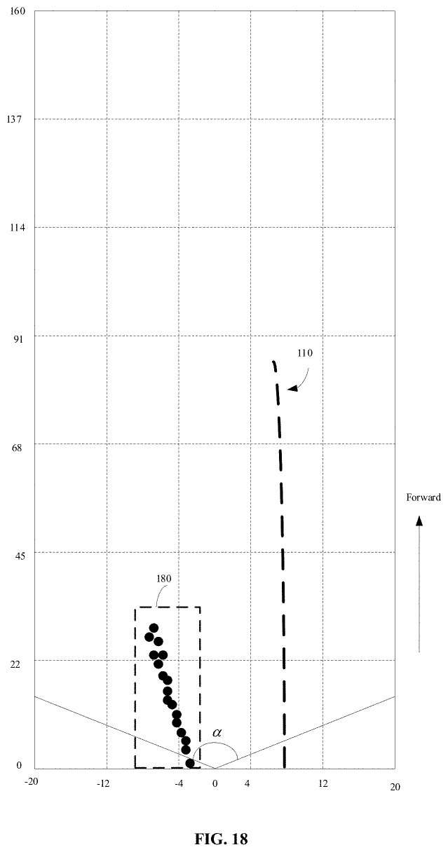

In addition, in some embodiments, after clustering the stationary target points detected by the radar at the current time, the cluster obtained may not match the continuous obstacle trajectory at the previous time, and the quality of the cluster may be greater than the predetermined quality threshold. As shown in FIG. 18, the cluster in a dotted line frame 180 is the cluster obtained by clustering the stationary target points detected by the radar at the current time, where the dotted line 110 represents the continuous obstacle trajectory at the previous time. By calculating the degree of match between the cluster points in the dotted line frame 180 and the continuous obstacle trajectory at the previous time, it can be determined that the degree of match is less than the predetermined degree of match, and the cluster points in the dotted line frame 180 cannot be associated with the continuous obstacle trajectory at the previous time. At this time, a new trajectory can be generated based on the cluster points in the dotted line frame 180. For example, the dotted line 110 may be a fence on the right, and the new trajectory may be a fence on the left. When a new trajectory is determined at a next time, it may be needed to calculate the degree of match between the cluster and the continuous obstacle trajectory at the previous time, and the degree of match between the cluster and the new trajectory corresponding to the cluster points in the dotted line frame 180 to determine to associate the cluster with the continuous obstacle trajectory at the previous time or the new trajectory.

In other embodiments, if the continuous obstacle trajectory at the previous time cannot be associated with the new trajectory corresponding to the cluster at each of the plurality of times after the previous time, then the part of the continuous obstacle trajectory at the previous time that exceeds the radar detection range will gradually disappear.

As shown in FIG. 18, the dotted line 110 represents the continuous obstacle trajectory at the previous time. The new trajectory corresponding to the cluster points in the dotted line frame 180 determined at the current time cannot be associated with the continuous obstacle trajectory at the previous time. If after the current time, the continuous obstacle trajectory at the previous time, such as the dotted line 110, is not associated with the new trajectory for a plurality of times, the dotted line 110 may gradually disappear as the vehicle continues to move forward. For example, a represents the detection range of the radar. As the vehicle continues to move forward, the dotted line 110 will gradually exceed the detection range of the radar. If the dotted line 110 is not associated with the new trajectory for a plurality of times, the dotted line 110 will gradually disappear. Similarly, if the new trajectory corresponding to the cluster points in the dotted line frame 180 is not associated with the new trajectory for a plurality of times in the future after the current time, the new trajectory corresponding to the cluster points in the dotted line frame 180 will gradually disappear as the vehicle continues to move forward.

In this embodiment, clustering processing can be performed on the stationary target points detected by the radar at the current time to obtain the cluster at the current time, and the degree of match between the cluster points at the current time and the continuous obstacle trajectory at the previous time can be calculated. If the degree of match between the cluster points at the current time and the continuous obstacle trajectory at the previous time is greater than the predetermined degree of match, the cluster points in the cluster at the current time can be associated with the continuous obstacle trajectory at the previous time to obtain the continuous obstacle trajectory at the current time. As such, the continuous obstacle trajectory can be continuously updated while the vehicle is moving.

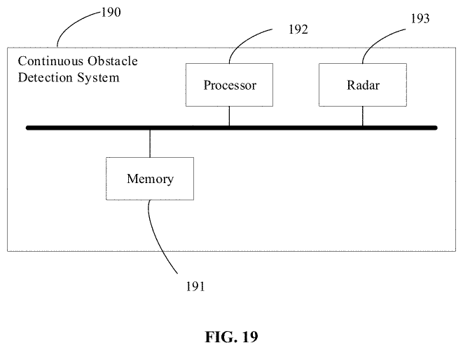

An embodiment of the present disclosure provides a continuous obstacle detection system. FIG. 19 is a structural diagram of a continuous obstacle detection system according to an embodiment of the present disclosure. As shown in FIG. 19, a continuous obstacle detection system 190 includes a memory 191, a processor 192, and a radar 193, where the radar 193 can be disposed on a vehicle. In some embodiments, the continuous obstacle detection system 190 may be a radar system. At this time, the processor 192 may be a signal processing unit of the radar 193. In other embodiments, the continuous obstacle detection system 190 may be a vehicle equipped with a radar. In this case, the processor 192 may be a vehicle-mounted processor. In other embodiments, the continuous obstacle detection system 190 may be a system composed of a vehicle equipped with a radar and a server 12 as shown in FIG. 1. At this time, the processor 192 may be the processor of the server 12 as shown in FIG. 1.

The radar 193 may include at least an antenna, and the antenna can be used to receive echo signals. The memory 191 can store program codes. The processor 192 can be configured to execute the program codes stored in the memory. When executed by the processor, the program codes can cause the processor to obtain the echo signal at the current time, and generate the detection data at the current time based on the echo signal; determine the stationary target points detected by the radar at the current time based on the detection data at the current time and the vehicle information of the vehicle at the current time; and determine a continuous obstacle trajectory at the current time based on the stationary target points detected by the radar at the current time.

In some embodiments, after determining the continuous obstacle trajectory at the current time based on the stationary target points detected by the radar at the current time, the processor 192 can be further configured to determine the boundary of the lane where the vehicle is positioned at the current time based on the continuous obstacle trajectory at the current time.

In some embodiments, the detection data may include one or more of the energy of a target point detected by the radar, or the distance, speed, angle of the target point relative to the radar.

In some embodiments, the vehicle information may include one or more of the speed, steering, or yaw rate of the vehicle.

In some embodiments, when determining the stationary target points detected by the radar at the current time based on the detection data at the current time and the vehicle information of the vehicle at the current time, the processor 192 may be configured to determine the stationary target points detected by the radar at the current time based on the speed of the vehicle at the current time, and the distance and speed of the target points detected by the radar at the current time relative to the radar.

In some embodiments, when determining the stationary target points detected by the radar at the current time based on the speed of the vehicle at the current time, and the distance and speed of the target points detected by the radar at the current time relative to the radar, the processor 192 may be configured to, if the distance of the target point relative to the radar detected by the radar at the current time is greater than a predetermined distance, compare the speed of the target point relative to the radar with the speed of the vehicle at the current time; and, if the different between the speed of the target point relative to the radar and the speed of the vehicle at the current time is less than a first predetermined difference, determine the target point as the stationary target point detected by the radar at the current time.

In some embodiments, when determining the stationary target points detected by the radar at the current time based on the speed of the vehicle at the current time, and the distance and speed of the target points detected by the radar at the current time relative to the radar, the processor 192 may be configured to, if the distance of the target point detected by the radar at the current time relative to the radar is less than or equal to the predetermined distance, determine the equivalent ground speed of the target point based on the angle of the target point relative to the radar; and compare the equivalent ground speed of the target point with the speed of the vehicle at the current time; and, if the difference between the equivalent ground speed of the target point and the speed of the vehicle at the current is less than a second predetermined difference, determine the target point as the stationary target point detected by the radar at the current time.

In some embodiments, the equivalent ground speed of the target point may be the radial speed of the target point relative to the radar.

In some embodiments, when determining the continuous obstacle trajectory at the current time based on the stationary target points detected by the radar at the current time, the processor 192 may be configured to generate the continuous obstacle trajectory at the current time based on the stationary target points detected by the radar at the current time.

In some embodiments, when generating the continuous obstacle trajectory at the current time based on the stationary target points detected by the radar at the current time, the processor 192 may be configured to perform clustering processing on the stationary target points detected by the radar at the current time to obtain the cluster at the current time; and generate the continuous obstacle trajectory at the current time based on the cluster at the current time if the quality of the cluster at the current time is greater than the predetermined quality threshold.

In some embodiments, before generating the continuous obstacle trajectory at the current time based on the cluster at the current time, the processor 192 may be further configured to determine the quality of the cluster at the current time based on one or more of the number of cluster points in the cluster at the current time, the length of the cluster, or the degree of match between the cluster and the vehicle information of the vehicle.

In some embodiments, when determining the continuous obstacle trajectory at the current time based on the stationary target points detected by the radar at the current time, the processor 192 may be configured to, based on the stationary target points detected by the radar at the current time, update the continuous obstacle trajectory at a previous time to obtain the continuous obstacle trajectory at the current time.

In some embodiments, when updating the continuous obstacle trajectory at a previous time to obtain the continuous obstacle trajectory at the current time based on the stationary target points detected by the radar at the current time, the processor 192 may be configured to perform clustering processing on the stationary target points detected by the radar at the current time to obtain the cluster at the current time; calculate the degree of match between the cluster points in the cluster at the current time and the continuous obstacle trajectory at the previous time; and associate the cluster points in the cluster at the current time with the continuous obstacle trajectory at the previous time to obtain the continuous obstacle trajectory at the current time if the degree of match between the cluster points in the cluster at the current time and the continuous obstacle trajectory at the previous time is greater than the predetermined degree of match.

In some embodiments, before calculating the degree of match between the cluster points in the cluster at the current time and the continuous obstacle trajectory at the previous time, the processor 192 may be further configured to determine the quality of the cluster at the current time based on one or more of the number of cluster points in the cluster at the current time, the length of the cluster, or the degree of match between the cluster and the vehicle information of the vehicle. When calculating the degree of match between the cluster points in the cluster at the current time and the continuous obstacle trajectory at the previous time, the processor 192 may be configured to calculate the degree of match between the cluster points in the cluster at the current time and the continuous obstacle trajectory at the previous time if the quality of the cluster at the current time is greater than the predetermined quality threshold.

In some embodiments, when calculating the degree of match between the cluster points in the cluster at the current time and the continuous obstacle trajectory at the previous time, the processor 192 may be configured to calculate the degree of match between the cluster points in the cluster at the current time and the continuous obstacle trajectory at the previous time based on the distance of the cluster points in the cluster relative to the radar at the current time and the distance of the previous trajectory points in the continuous obstacle trajectory at the previous time relative to the radar; and/or, calculate the degree of match between the cluster points in the cluster at the current time and the continuous obstacle trajectory at the previous time based on the speed of the cluster points in the cluster relative to the radar at the current time and the speed of the previous trajectory points in the continuous obstacle trajectory at the previous time relative to the radar.

In some embodiments, when calculating the degree of match between the cluster points in the cluster at the current time and the continuous obstacle trajectory at the previous time, the processor 192 may be configured to perform parameter fitting on the cluster at the current time to obtain the parameter information of the new trajectory corresponding to the cluster at the current time; and calculate the degree of match between the cluster points at the current time and the continuous obstacle trajectory at the previous time based on the parameter information of the new trajectory corresponding to the cluster at the current time and the parameter of the continuous obstacle trajectory at the previous time.

In some embodiments, when the processor 192 performs parameter fitting on the cluster at the current time, it may use one or more of a polynomial fitting method to perform parameter fitting on the cluster at the current time, or a radius arc fitting method to perform parameter fitting on the cluster at the current time.

In some embodiments, when associating the cluster points in the cluster at the current time with the continuous obstacle trajectory at the previous time to obtain the continuous obstacle trajectory at the current time, the processor 192 may be configured to obtain the new trajectory corresponding to the cluster at the current time based on the cluster points in the cluster at the current time; and, associate the new trajectory corresponding to the cluster at the current time with the continuous obstacle trajectory at the previous time to obtain the continuous obstacle trajectory at the current time, the continuous obstacle trajectory at the current time including the new trajectory and the continuous obstacle trajectory at the previous time.

In some embodiments, the new trajectory may be connected to the continuous obstacle trajectory at the previous time.

In some embodiments, the new trajectory may not be connected to the continuous obstacle trajectory at the previous time.

In some embodiments, when associating the cluster points in the cluster at the current time with the continuous obstacle trajectory at the previous time to obtain the continuous obstacle trajectory at the current time, the processor 192 may be configured to associate the cluster points in the cluster at the current time with the previous trajectory points in the continuous obstacle trajectory at the previous time to obtain the target points of the continuous obstacle trajectory at the current time; and, determine the continuous obstacle trajectory at the current time based on the target points of the continuous obstacle trajectory at the current time.

In some embodiments, if the continuous obstacle trajectory at the previous time cannot be associated with the new trajectory corresponding to the cluster at each of the plurality of times after the previous time, then the part of the continuous obstacle trajectory at the previous time that exceeds the radar detection range will gradually disappear.

In some embodiments, the radar may be a millimeter wave radar.

In this embodiment, the echo signal at the current time can be obtained, the detection data at the current time can be generated based on the echo signal, the stationary target points detected by the radar at the current time can be determined based on the detection data at the current time and the vehicle information of the vehicle at the current time, and continuous obstacle trajectory at the current time can be determined based on the stationary target points detected by the radar at the current time, thereby realizing the detection of continuous obstacles around the vehicle.

An embodiment of the present disclosure provide a vehicle. The vehicle may include a vehicle body, a power system, and the continuous obstacle detection system described in the above embodiment. The power system can be disposed on the vehicle body to provide power. The implementation method and specific principles of the continuous obstacle detection system are consistent with the foregoing embodiment, which will not be repeated here.

In addition, an embodiment of the present disclosure provides a computer-readable storage medium having a computer program stored thereon. The computer program can be executed by a processor to implement the continuous obstacle detection method described in the foregoing embodiments.

In the several embodiments provided by the present disclosure, it should be understood that the disclosed apparatus and method may be implemented in other manners. For example, the apparatus embodiments described above are merely illustrative. For example, the unit division is merely logical function division and there may be other division in actual implementation. For example, multiple units or components may be combined or integrated into another system, or some features can be omitted or not be executed. In addition, the mutual coupling or the direct coupling or the communication connection as shown or discussed may be indirect coupling or communication connection through some interfaces, devices or units, and may be in electrical, mechanical or other forms.

The units described as separate components may or may not be physically separated. The components displayed as units may or may not be physical units, that is, may be located in one place or may also be distributed to multiple network units. Some or all of the units may be selected according to actual needs to achieve the objectives of the solution in the disclosure.

In addition, each functional unit in each embodiment of the present disclosure may be integrated into one processing unit, or each unit may exist alone physically, or two or more units may be integrated in one unit. The above-mentioned integrated unit can be implemented in the form of hardware or in the form of hardware plus software functional unit.

The above-described integrated unit implemented in the form of a software functional unit may be stored in a computer-readable storage medium. The software function unit is stored in a storage medium and includes several instructions for enabling a computer device (which may be a personal computer, a server, a network device, etc.) or a processor to execute some steps of the method according to each embodiment of the present disclosure. The foregoing storage medium includes a medium capable of storing program code, such as a USB flash disk, a removable hard disk, a read-only memory (ROM), a random access memory (RAM), a magnetic disk, an optical disc, or the like.

Those skilled in the art may clearly understand that, for convenience and brevity of description, the division of the foregoing functional modules is only used as an example. In practical applications, however, the above function allocation may be performed by different functional modules according to actual needs. That is, the internal structure of the device is divided into different functional modules to accomplish all or part of the functions described above. For the working process of the foregoing apparatus, reference may be made to the corresponding process in the foregoing method embodiments, and details are not described herein again.

Finally, it should be noted that the foregoing embodiments are merely intended for describing the technical solutions of the present disclosure, but not to limit the present disclosure. Although the present disclosure is described in detail with reference to the foregoing embodiments, it should be understood by those of ordinary skill in the art that the technical solutions described in the foregoing embodiments may still be modified, or a part or all of the technical features may be equivalently replaced without departing from the spirit and scope of the present disclosure. As a result, these modifications or replacements do not make the essence of the corresponding technical solutions depart from the scope of the technical solutions of the present disclosure.

What is claimed is:

1. A continuous obstacle detection method applied to a vehicle having a radar including an antenna configured to receive an echo signal, comprising:
obtaining the echo signal at a current instance, and generating detection data at the current instance based on the echo signal;
determining a plurality of stationary target points detected by the radar at the current instance based on the detection data at the current instance and vehicle information of the vehicle at the current instance; and
determining a continuous obstacle trajectory at the current instance based on the plurality of stationary target points detected by the radar at the current instance.

2. A continuous obstacle detection system comprising:
a radar disposed on a vehicle, the radar including an antenna, the antenna being configured to receive an echo signal;
a processor; and
a memory storing one or more sets of instruction sets that, when executed by the processor, causes the processor to:
obtain the echo signal at a current instance, and generate detection data at the current instance based on the echo signal;
determine a plurality of stationary target points detected by the radar at the current instance based on the detection data at the current instance and vehicle information of the vehicle at the current instance; and
determine a continuous obstacle trajectory at the current instance based on the plurality of stationary target points detected by the radar at the current instance.

3. The system of claim 2, wherein after determining the continuous obstacle trajectory at the current instance based on the plurality of stationary target points detected by the radar at the current instance, the processor is further configured to:
determine a boundary of a lane where the vehicle is positioned at the current instance based on the continuous obstacle trajectory at the current instance.

4. The system of any one of claim 2, wherein:
the detection data includes one or more of an energy of the target point detected by the radar, or a distance, speed, and angle of the target point relative to the radar.

5. The system of claim 2, wherein:
the vehicle information includes one or more of a speed, steering, or yaw rate of the vehicle.

6. The system of claim 2, wherein when determining the plurality of stationary target points detected by the radar at the current instance based on the detection data at the current instance and vehicle information of the vehicle at the current instance, the processor is configured to:
determining the plurality of stationary target points detected by the radar at the current instance based on the speed of the vehicle at the current instance, and the distance and speed of the target point detected by the radar at the current instance relative to the radar.

7. The system of claim 6, wherein when determining the plurality of stationary target points detected by the radar at the current instance based on the speed of the vehicle at the current instance, and the distance and speed of the target point detected by the radar at the current instance relative to the radar, the processor is configured to:
compare the speed of the target point relative to the radar and the speed of the vehicle at the current instance if the distance of the target point detected by the radar at the current instance relative to the radar is greater than a predetermined distance; and
determine the target point as the stationary target point detected by the radar at the current instance if a difference between the speed of the target point relative to the radar and the speed of the vehicle at the current instance is less than a first predetermined difference.

8. The system of claim 6, wherein when determining the plurality of stationary target points detected by the radar at the current instance based on the speed of the vehicle at the current instance, and the distance and speed of the target point detected by the radar at the current instance relative to the radar, the processor is configured to:
determine an equivalent ground speed of the target point based on an angle to the target point relative to the radar if the distance of the target point detected by the radar at the current instance relative to the radar is less than or equal to the predetermined distance;
compare the equivalent ground speed of the target point with the speed of the vehicle at the current instance; and
determine the target point as the stationary target point detected by the radar at the current instance if a difference between the equivalent ground speed of the target point and the vehicle at the current instance is less than a second predetermined difference.

9. The system of claim 8, wherein
the equivalent ground speed of the target point is a radial speed of the target point relative to the radar.

10. The system of claim 2, wherein when determining the continuous obstacle trajectory at the current instance based on the plurality of stationary target points detected by the radar at the current instance, the processor is configured to:
generate the continuous obstacle trajectory at the current instance based on the stationary target points detected by the radar at the current instance.

11. The system of claim 10, wherein when generating the continuous obstacle trajectory at the current instance based on the stationary target points detected by the radar at the current instance, the processor is configured to:
perform clustering processing on the stationary target points detected by the radar at the current instance to obtain a cluster at the current instance; and
generate the continuous obstacle trajectory at the current instance based on the cluster at the current instance if a quality of the cluster at the current instance is greater than a predetermined quality threshold.

12. The system of claim 11, wherein before generating the continuous obstacle trajectory at the current instance based on the cluster at the current instance, the processor is further configured to:
determine the quality of the cluster at the current instance based on one or more of a number of cluster points in the cluster at the current instance, a length of the cluster, or a degree of match between the cluster and the vehicle information of the vehicle.

13. The system of claim 2, wherein when determining the continuous obstacle trajectory at the current instance based on the plurality of stationary target points detected by the radar at the current instance, the processor is configured to:
update the continuous obstacle trajectory at a previous instance to obtain the continuous obstacle trajectory at the current instance based on the stationary target points detected by the radar at the current instance.

14. The system of claim 13, wherein when updating the continuous obstacle trajectory at the previous instance to obtain the continuous obstacle trajectory at the current instance based on the stationary target points detected by the radar at the current instance, the processor is configured to:
perform clustering processing on the stationary target points detected by the radar at the current instance to obtain the cluster at the current instance;
calculate the degree of match between the cluster points in the cluster at the current instance and the continuous obstacle trajectory at the previous instance; and
associate the cluster points in the cluster at the current instance with the continuous obstacle trajectory at the previous instance to obtain the continuous obstacle trajectory at the current instance if the degree of match between the cluster points in the cluster at the current instance and the continuous obstacle trajectory at the previous instance is greater than a predetermined degree of match.

15. The system of claim 14, wherein before calculating the degree of match between the cluster points in the cluster at the current instance and the continuous obstacle trajectory at the previous instance, the processor is further configured to:
determine the quality of the cluster at the current instance based on one or more of the number of cluster points in the cluster at the current instance, the length of the cluster, or the degree of match between the cluster and the vehicle information of the vehicle; and
when calculating the degree of match between the cluster points in the cluster at the current instance and the continuous obstacle trajectory at the previous instance, the processor is configured to:
calculate the degree of match between the cluster points in the cluster at the current instance and the continuous obstacle trajectory at the previous instance if the quality of the cluster at the current instance is greater than the predetermined quality threshold.

16. The system of claim 14, wherein when calculating the degree of match between the cluster points in the cluster at the current instance and the continuous obstacle trajectory at the previous instance, the processor is configured to:
calculate the degree of match between the cluster points in the cluster at the current instance and the continuous obstacle trajectory at the previous instance based on a distance of the cluster point in the cluster relative to the radar at the current instance and a distance of a previous trajectory point in the continuous obstacle trajectory at the previous instance relative to the radar; and
calculate the degree of match between the cluster points in the cluster at the current instance and the continuous obstacle trajectory at the previous instance based on a speed of the cluster point in the cluster relative to the radar at the current instance and a speed of the previous trajectory point at the previous instance relative to the radar.

17. The system of claim 14, wherein when calculating the degree of match between the cluster points in the cluster at the current instance and the continuous obstacle trajectory at the previous instance, the processor is configured to:
perform parameter fitting on the cluster at the current instance to obtain parameter information of a new trajectory corresponding to the cluster at the current instance;
calculate the degree of match between the cluster points in the cluster at the current instance and the continuous obstacle trajectory at the previous instance based on the parameter information of the new trajectory corresponding to the cluster at the current instance and the parameter information of the continuous obstacle trajectory at the previous instance.

18. The system of claim 14, wherein when associating the cluster points in the cluster at the current instance with the continuous obstacle trajectory at the previous instance to obtain the continuous obstacle trajectory at the current instance, the processor is configured to:
obtain the new trajectory corresponding to the cluster at the current instance based on the cluster points in the cluster at the current instance; and
associate the new trajectory corresponding to the cluster at the current instance with the continuous obstacle trajectory at the previous instance to obtain the continuous obstacle trajectory at the current instance, the continuous obstacle trajectory at the current instance including the new trajectory and the continuous obstacle trajectory at the previous instance.

19. The system of claim 18, wherein:
the new trajectory is connected to the continuous obstacle trajectory at the previous instance.

20. The system of claim 18, wherein:
the new trajectory is not connected to the continuous obstacle trajectory at the previous instance.
